(19) United States
(12) Patent Application Publication
(10) Pub. No.: US 2009/0248237 A1
(43) Pub. Date: Oct. 1, 2009

(54) METHODS AND SYSTEMS FOR USER CONFIGURABLE EMBEDDED TELEMATICS SERVICE ARCHITECTURE

(76) Inventors: Gerhard A. Koepf, Boulder, CO (US); Robert M. Yandroflki, Denver, CO (US); Jonathan M. Cooper, Denver, CO (US)

Correspondence Address: SQUIRE SANDERS & DEMPSEY LLP, TWO RENAISSANCE SQUARE, 40 NORTH CENTRAL AVENUE, SUITE 2700, PHOENIX, AZ, 85004-4498, US

(21) Appl. No.: 12/059,969

(22) Filed: Mar. 31, 2008

(51) Int. Cl. G06F 17/00

(52) U.S. Cl. 701/33; 701/1

(57) ABSTRACT

The present invention provides a configurable embedded telematics system comprising: a server suite providing automotive telematics services to a plurality of authorized service users via a global network, the server suite including a user management utility, an application server, a vehicle interface module server, a telematics database, and a user configuration utility; and a vehicle interface module including an operations controller, an on-board resource and an on-board application comprising an event monitor module, a data logging module, and a user configuration module.

### FIELD OF THE INVENTION

The present invention relates generally to telematics methods and systems and more particularly, to the configuration of telematics systems and devices.

### BACKGROUND OF THE INVENTION

Telematics systems typically combine telecommunications and information processing, and frequently involve automobile systems that combine global positioning system (GPS) satellite tracking and wireless communications for automatic roadside assistance and remote diagnostics. Some vehicle telematics systems monitor for vehicle diagnostic trouble codes that are formed from sensory inputs from various electronic modules in the vehicle.

Telematics systems promise to combine vehicle safety, entertainment and convenience features through wireless access to distributed networks, such as the Internet. Such systems are distinguishable from hardware-centric audio and vehicle control systems that are built into devices custom designed for each vehicle. By contrast, vehicle telematics systems may include infotainment delivered by plug-and-play hardware whose functionality can be upgraded through software loads or simple module replacement. It is anticipated that significant new revenue streams will be opened up to automobile manufacturers and service providers through the products and services made available through telematics systems.

In the field of vehicle telematics, technologies have been devised that contribute to expanding the use of commercial and personal vehicles from merely a form of transportation to acting as communication hubs. According to these technologies, a vehicle is able to communicate wirelessly with remote systems in order to serve or facilitate a number of objectives including objectives related to safety, navigation, information gathering, entertainment and education. Communications with the vehicle typically involve a cellular phone or other communication device that is able to send and receive communications from outside the vehicle.

Beginning with model year 1996, the Environmental Protection Agency (EPA) required vehicle manufacturers to install on-board diagnostics (OBD-II) for monitoring light-duty automobiles and trucks. OBD-II systems include microcontrollers and sensors that monitor the vehicle's electrical and mechanical systems and generate data that are processed by a vehicle's engine control unit (ECU) to detect any malfunction or deterioration in the vehicle's performance. Most ECUs transmit status and diagnostic information over a shared, standardized electronic bus in the vehicle, which effectively functions as an on-board computer network with many processors that transmit and receive data. The primary computers in this network are the vehicle's electronic-control module (ECM) for monitoring engine functions and power-control module (PCM) for monitoring the vehicle's power train. Data available from the ECM and PCM include vehicle speed, fuel level, engine temperature, and intake manifold pressure.

Data from the above-mentioned systems are made available through a standardized, serial 16-pin OBD-II connector, which usually is disposed underneath the vehicle's dashboard. When the vehicle is serviced, data from the vehicle's ECM and/or PCM is typically queried using an external power train-diagnostic tool that plugs into the OBD-II connector. The vehicle's engine is turned on and data is transferred from the engine computer, through the OBD-II connector, and to the external engine-diagnostic tool. The data, in the form of diagnostic trouble codes, is then displayed and analyzed to service the vehicle. Some vehicle manufacturers also include complex electronic systems in their vehicles to access and analyze some of the above-described data. Such systems collect and transmit data through a wireless network. These systems are not connected through the OBD-II connector, but instead are wired directly to the vehicle's electronic system when the vehicle is manufactured.

### SUMMARY OF THE INVENTION

The present invention relates generally to telematics methods and systems and more particularly, to the configuration of telematics systems and devices. In accordance with various embodiments, a configurable embedded telematics system might include a server suite, including a user management utility and an application server. In some embodiments the configurable embedded telematics system may also include, a telematics database, a user configuration utility, a vehicle interface module and a vehicle interface module server. The vehicle interface module may include an operations controller, on-board resources and an on-board application. In some embodiments, the on-board resources may comprise a resource for communication on a global network, a resource for determining geo-location and a resource for interfacing with vehicle electronic networks, an event monitor module, a data logging module, and a user configuration module. According to various embodiments, the vehicle interface module may also include a global network.

In accordance with various embodiments, the on-board application further comprises a communications module configured to control data transport exchange with the global network, an alert module configured to trigger user alerts, a location module configured to process and log location data and a data logging module configured to filter and store data received from the electronic vehicle networks. In some embodiments, the on-board application may further comprise a command module configured to execute user commands to the vehicle. Additionally, in some embodiments, the vehicle interface module may further comprise a power control module configured to control a plurality of operational power modes.

In accordance with various embodiments, the server suite may further comprise an operation and maintenance entity configured to provide service infrastructure monitoring and maintenance. In some embodiments, the operations and maintenance entity may further comprise a vehicle interface module diagnostic service utility. Additionally, in some embodiments, a configurable embedded telematics system may further comprise a diagnostic module.

In accordance with various embodiments, a configurable embedded telematics system might include a user configuration utility comprising a vehicle adaptation utility. The configurable embedded telematics system might include a user configuration module comprising a vehicle configuration module. In various embodiments, a user configuration utility may comprise a service adaptation utility. In some embodiments, the user configuration module comprises a service configuration module. In various embodiments, the user configuration utility might comprise a wireless adaptation utility and the user configuration module may comprise a wireless configuration module. Additionally, in some embodiments, a configurable embedded telematics system might be further configured to allow a user to set a notification preference.

Other features and advantages of the present invention should become apparent from the following description of the preferred embodiments, taken in conjunction with the accompanying drawings, which illustrate, by way of example, the principles of the invention.

### BRIEF DESCRIPTION OF THE DRAWINGS

Embodiments of the present invention will now be described, by way of example only, with reference to the following drawings, in which:

FIG. 1 is a diagram illustrating an example telematics service architecture in accordance with the systems and methods described herein;

FIG. 2 is a diagram illustrating an example of on-board applications in accordance with the example of FIG. 1;

FIG. 3 is a diagram illustrating an example of configurable on-board resources in accordance with the example of FIG. 1;

FIG. 4 is a diagram illustrating an example of user configurable telematics architecture in accordance with the systems and methods described herein;

FIG. 5 is a diagram illustrating an example of remote vehicle adaptation in accordance with the example of FIG. 4;

FIG. 6 is a diagram illustrating an example of remote service adaptation in accordance with the example of FIG. 4;

FIG. 7 is a diagram illustrating an example of remote wireless adaptation in accordance with the example of FIG. 4; and

FIG. 8 is a diagram illustrating an example vehicle interface module in accordance with the systems and methods described herein.

### DETAILED DESCRIPTION OF THE PREFERRED EMBODIMENTS

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

The present invention relates generally to telematics systems and methods and more particularly, to the configuration of telematics systems and devices. In accordance with various embodiments, a configurable embedded telematics system might include a server suite, including a user management utility and an application server. In some embodiments the configurable embedded telematics system may also include a vehicle interface module server, a telematics database, a user configuration utility, and a vehicle interface module. The vehicle interface module may include an operations controller, on-board resources and an on-board application. In some embodiments, the on-board application may comprise an event monitor module, a data logging module and a user configuration module. In various embodiments, the vehicle interface module may also include a resource for communicating with a global network.

Before starting a description of the Figures, some terms will now be defined.

Activated VIM: A vehicle interface module (VIM) having an activated communication service with a wireless service provider (in case of Global System for Mobile Communications (GSM) service, using a Subscriber Identity Module (SIM) card activation process).

Configuration PC: A computer used (e.g., by a dealership service technician) for configuring and testing VIMs prior to and/or during installation.

Default Configuration File: A vehicle-specific network protocol that may be used for functional testing at the manufacturer, and may be replaced during installation.

Flat File: A list containing manufactured VIMs and associated identifiers that may be shipped to an appropriate dealership.

Functional Test: A test performed (e.g., at the manufacturer) to verify functional compliance with various system requirements, for example, before shipping and installation.

Installation PC: A computer used (e.g., by the manufacturer) (i) to perform various functions such as the installation of VIM platform firmware and software applications (e.g., on-board application, modem configuration, and vehicle default configuration), and/or (ii) to perform a Functional Test.

Installation Verification Test: A test performed (e.g., by a dealership service technician) to verify the functional operation of installed VIMs.

Modem: A wireless transceiver for wireless VIM communications with a server (e.g., of the telematics services provider) for example, on a global network.

Modem Configuration: A process for VIM-specific modem configuration (e.g., including modem identifiers, SIM card configuration data, a server static IP number, and wireless service provider identifiers).

OBD-II: A vehicle's on-board diagnostic port that can be used to communicate with electronic vehicle networks and harnesses.

Off-Board Application: A software application (e.g., residing on the installation PC) that may be used for installing firmware files, on-board application files, default configuration files (modem and vehicle), and/or functional test software.

On-Board Application: An embedded software application that interfaces with the VIM platform over application programming interfaces and controls the operation of the VIM during VIM operation.

Functional Test Application: A software application (e.g. residing on the installation PC) that interfaces with the VIM platform over application programming interfaces and controls the operation of the VIM during VIM functional testing.

Operational SIM Card : A subscriber identity module (SIM) card activated for service on a wireless network and used for VIM communications with a server of the telematics services provider during operation.

SIM Activation: A process for activating wireless service.

Telematics Database: A central database that is part of the telematics server suite of the telematics services provider (e.g., used for storing vehicle related information such as vehicle identity data, vehicle operational data, vehicle owner data, and telematics service data).

Telematics Web Portal: A web portal with rule-based access for telematics services users such as customers and dealership service technicians.

Test SIM Card: A SIM card that may be activated for wireless service and used for temporary functional testing (e.g., at the manufacturer's location).

Vehicle Configuration File: A vehicle-specific network protocol that provides communications between a VIM and a specific vehicle make and model.

VIM: A vehicle interface module that includes a VIM platform and an on-board application.

VIM Association: A database association between (i) a specific VIM, identified by one or more unique VIM identifiers, modem identifiers, and/or SIM card identifiers, and (ii) a specific vehicle, identified by a unique VIN and other features such as make, model, year, and color, and (iii) a vehicle owner.

VIM Inventory: A record of VIMs (e.g., at a dealership), including activated and non-activated VIMs, that is delivered from manufacturer but not yet installed in vehicles.

VIM Platform: A platform including, e.g., (i) a housing with interconnects to the vehicle (OBDII) configuration and installation PC (serial port), communications antenna, and GPS antenna, (ii) a circuit board with processor, wireless modem, GPS receiver, vehicle electronic network interface hardware, power supply, serial port interface, and memory, which may all be connected by one or more data buses, (iii) firmware controlling operation of the wireless modem, the GPS receiver and vehicle network drivers, and (iv) application programming interfaces to the on-board application, which may, for example, be embedded in the processor.

Before describing the invention in detail, it is useful to describe an example environment with which the invention can be implemented. In a telematics service architecture a telematics service provider may operate one or more telematics server suits. The telematics server suites may provide automotive telematics services to a plurality of authorized service users via a global network. The architecture may further comprise a plurality of vehicles. These vehicles may include electronic networks, such as control area networks, UART based networks, discrete analog/digital input/output ports, etc. Additionally, these vehicles might include a plurality of vehicle interface modules, generally one per vehicle, and connected to the vehicle's electronic networks.

The configurable embedded telematics architecture may further comprise one or more wireless communications networks connected to the global network for bidirectional data transport between the VIMs and the one or more telematics server suits. The server suites may encompass all the system control and data management utilities, user and vehicle access interfaces, and service applications needed to support the automotive telematics services supported by the plurality of vehicle interface modules. Authorized service users might be, for example, individuals that own vehicles or personnel in organizations that own vehicles or own fleets of vehicles. Authorized service users might also be, for example, groups of individuals that work with vehicles or vehicle data in various roles. In some embodiments, to qualify as an authorized service user the user needs to be registered with the telematics service provider.

In some embodiments, telematics service users may have a need for communication with remote vehicles via a communications network. Actual service interests, interactions between users, servers and vehicles, however, may vary widely between users and user groups. Services might comprise upstream vehicle initiated data transport, downstream vehicle initiated data transport, user initiated data transport, server initiated data transport, or some combination of these.

In various embodiments, data collection from vehicles might include data collection while moving or parked. For example, while a vehicle is in operation, a large amount of vehicle data may be available on one or more of the vehicle electronic networks. A specific telematics service may be characterized by the specific portion of available vehicle data that is selected, monitored, processed, stored, forwarded, or some combination of these. A telematics service might be forwarded to the user or server suite for immediate or later use. In some embodiments, the use of VIM resources, such as processing power and memory, might be designed to improve economical service operation.

In various embodiments, upstream services may include, for example, critical event detection, e.g., theft, accident, etc.; driver performance monitoring, speed, rpm, idle time, max speed, etc.; instant vehicle diagnostics, e.g., detection of diagnostic trouble codes, break action, etc. In some embodiments, upstream services may include, for example, long-term vehicle wear and tear monitoring, e.g., power-train, transmission, break system, tire pressure, oil and other fluid quality and quantity, etc.; location finding, e.g., tracking, navigation, etc. In some embodiments, only data that is time critical may be sent upstream in real time, while other service related data may be stored for possible later retrieval.

Some embodiments of the systems and methods described herein might include user-vehicle interactions. For example, these services might comprise commands to vehicle subsystems and components or data queries to the vehicle. For example, in various embodiments, users may send downstream commands to the VIM to query vehicle location, diagnostic trouble code and/or vehicle drive status, or to remotely operate door locks, windows, heating/cooling systems, horns and lights, or even enable/disable the engine.

Generally, not all users and user groups of a telematics system might desire or need the same services. In some embodiments, services may differ in the type and amount of data collected from vehicles either in real time or in a store and forward operation and in the way access to this data is provided. A telematics service architecture that includes all user services requires a commensurate large range of VIM processing and memory resources. In contrast a telematics service architecture that is limited to services requested by users or user groups might require much lesser VIM processing and memory resources.

In some embodiments, user services might also differ in the amount of data transport resources consumed. For example a tracking service may require periodic location updates at a rate of a few seconds, while a trip metering service only requires a data transfer at the beginning and at the end of an ignition cycle. In some cases, the wireless part of the data transport may be metered by the wireless service provider. Limiting the data transport to those services that a user or user group consumes, preserves wireless data transport resources and might lower cost to the user, for example, when cost of wireless services are set based on usage rather than a fixed fee.

In some embodiments, manufacturers might equip vehicles with a variety of standard electronic networks such as single-wire and dual-wire control area networks (CANs), high-speed CANs, Fault Tolerant CANS, Class 2, UART based networks such as ISO and K-line, and others. The physical layers of these networks may be standardized. However, actual networks implemented in a vehicle as well as the actual message libraries used to communicate on these networks might vary from manufacturer to manufacturer. Additionally, these networks might vary from model to model or model year to model year, even within the same manufacturer. To be independent of a specific vehicle manufacturer, model or year, a telematics service architecture may need to provide a model specific VIM configuration capability.

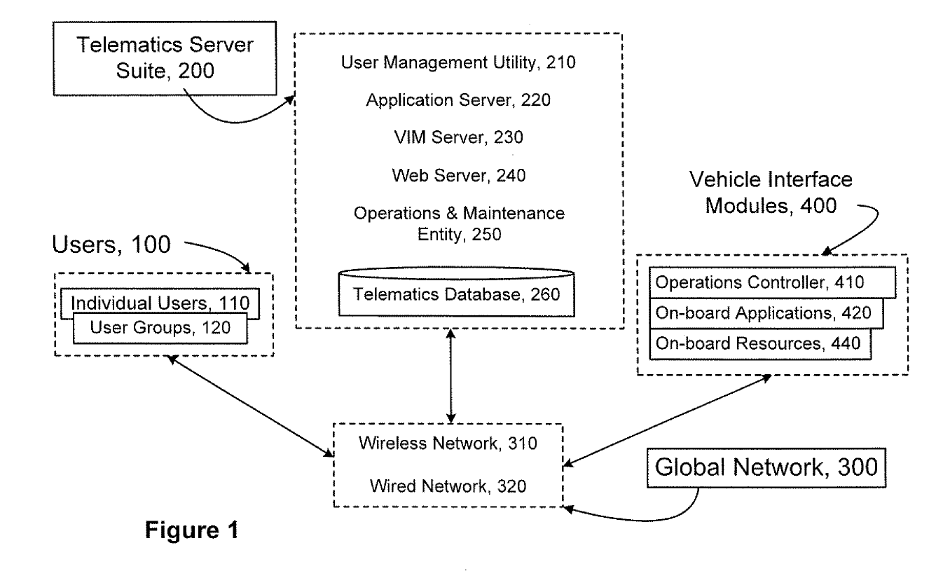

FIG. 1 is a diagram illustrating an example telematics service architecture in accordance with the systems and methods described herein. The fixed telematics service architecture in FIG. 1 comprises a plurality of authorized telematics service users 100, one or more configurable telematics service suite(s) 200, a global network 300, and a plurality of vehicles with vehicle interface modules 400. In some embodiments, the plurality of telematics service users 100 might include individual vehicle users 110, fleet owners, car dealers, service technicians, vehicle manufacturers and their suppliers. Additionally, in various embodiments, the plurality of telematics service users 100 might also include development partners, car insurance companies, car finance institutions, customer service, emergency/security/safety agents, and others. In some embodiments, authorized users may not be restricted to being vehicle operators. In various embodiments, users 100 may be grouped into user groups 120 based on organizations, functions and services, billing-practices, access authorization level or other criteria.

The server suite 200 includes one or more servers, which may be co-located or distributed geographically and may comprise a user management utility 210. The user management utility 210 may control and manage user access, store user profiles, monitor user service consumption and billing. Additionally, the user management utility 210 may include application server 220 with a plurality of service applications. VIM server 230 may establish and maintain data connections between the plurality of vehicles and service applications. In some applications, web server 240 might provide interactive user access to telematics services. In various embodiments, operation and maintenance entity 250 may provide service infrastructure monitoring and maintenance. Additionally, telematics database 260 may store and retrieve user, service and vehicle data records.

In the illustrated embodiment, the global network 300 may comprise one or more wireless network portions 310, one or more wired network portions 320, or a combination thereof. In some embodiments, network portions 310 and 320 might be integrated in such a way that VIM's can bi-directionally communicate with fixed devices on the wired portions while moving. The wired network portion may include an internet connection, telephone connection, other wired communication systems, or some combination of systems. The wireless portion may be a cellular or PCS network, a WiFi or Imax network, a satellite network or any other wireless network or combination of wireless networks.

In some embodiments, the plurality of VIM's 400 may provide the embedded component of the configurable telematics service architecture. In various embodiments, the VIM may be an integrated hardware module. As illustrated in FIG. 1, the VIM 400 might include an operations controller 410, a plurality of on-board applications 420, and a plurality of on-board resources 440. Additionally, in some embodiments, the VIM 400 may include one or more on-board resource controllers, and may comprise an event driven device. It may, for example, monitor a vehicle's electronic networks for vehicle events. Additionally, it might monitor a global network for user initiated events and its internal operation for application induced events. In some embodiments, events might trigger sequences of actions that are executed by operations controller 410, for example, according to priority rules. Execution of lower priority events may, in some embodiments, be interrupted when a higher priority event is detected. In various embodiments, event execution might generally involve executing one or more of the plurality of on-board application. At various times, the operations controller 410 may be in the process of executing a number of events.

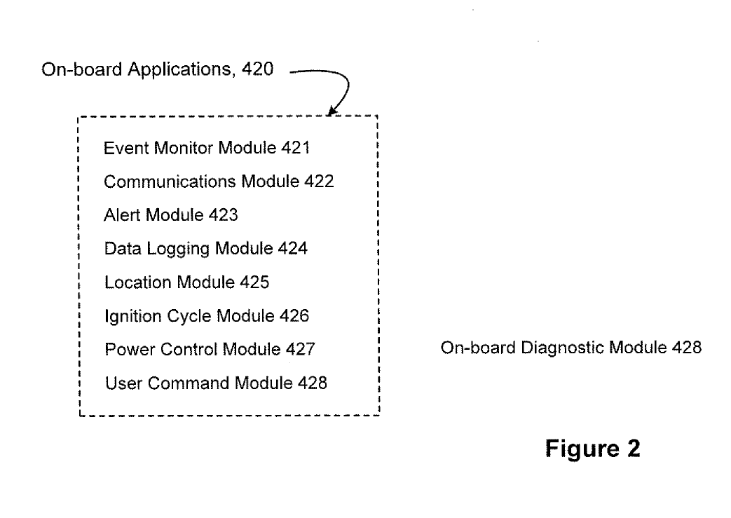

FIG. 2 is a diagram illustrating an example of on-board applications in accordance with the example of FIG. 1. In some embodiments, the plurality of on-board applications 420 in FIG. 2 might comprise an event monitor module 421. The event monitor module 421 may detect events, rank these in terms of priority and pass execution instructions to the operations controller 410. In some embodiments, a communications module 422 may control the data transport exchange with the server suite, an alert module 423 may trigger user alerts and a data logging module 424 may filter, process and log vehicle data. Additionally, a location module 425 may filter, process and log location data, an ignition cycle module 426 may process and log ignition cycle data sets and a power control module 427 may control the VIM operating mode transitions. In some embodiments, a user command module 428 might execute user commands. These and other on-board applications not shown in FIG. 2 might provide functions and features for serving authorized users with specific telematics services.

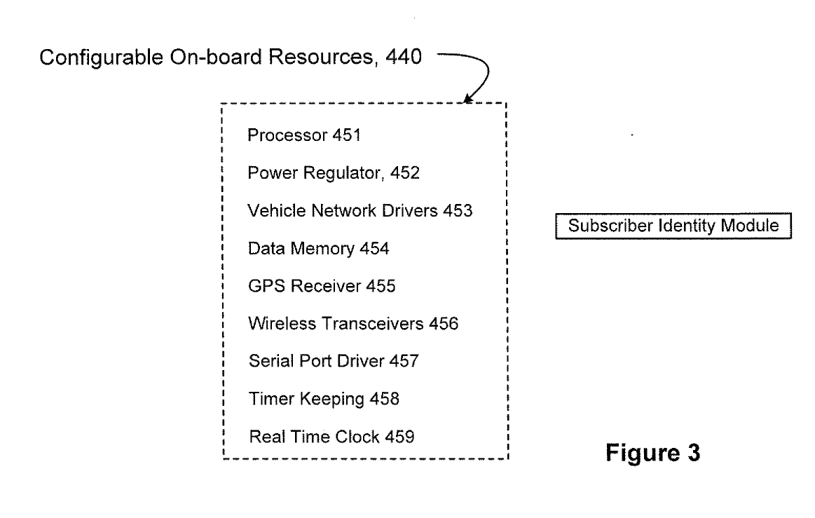

FIG. 3 is a diagram illustrating an implementation of configurable on-board resources in accordance with the example of FIG. 1. Execution of on-board applications in general involves accessing VIM on-board resources 440. For example, such on-board resources 440 may comprise a processor 451, a power regulator 452, a vehicle network driver 453, a data memory device 454, a GPS receiver 455, and one or more wireless transceivers 456. Additionally, the on-hoard resources 440 might include a serial port driver 457, timers 458, and a real time clock 459. In various embodiments, additional on-board resources may be added to provide other service features and functions.

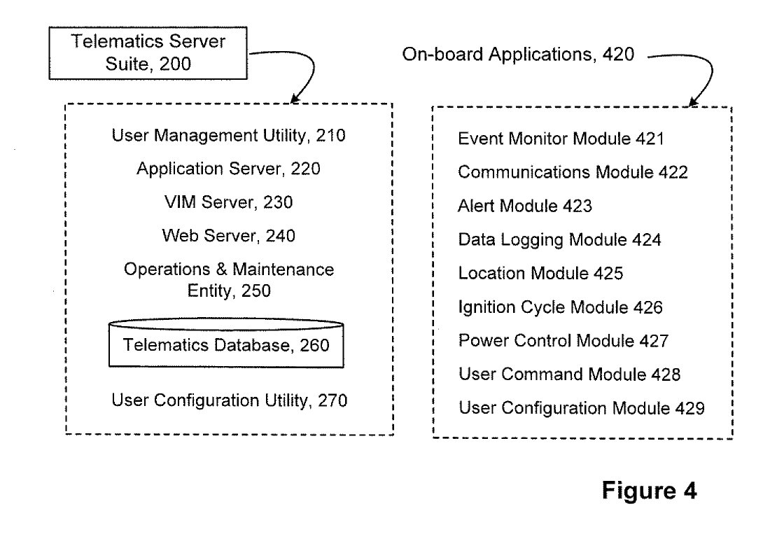

FIG. 4 is a diagram illustrating an example user configurable telematics architecture in accordance with the systems and methods described herein. The user configurable telematics service architecture illustrated in FIG. 4 introduces two components to the fixed service architecture; namely, a user configuration utility 270 and a user configuration module 429. In various embodiments, the user configuration utility 270 may be added to telematics server suite 200, and the user configuration module 429 might be added to onboard modules 420.

In some embodiments, the introduction of these components in combination with over-the-air access from the wired portion of the global network, might allow authorized users and user groups to customize telematics services so as to meet these user's specific requirements. In some embodiments, the user configuration utility and user configuration module may be designed in such a way as to minimize the need for on-board resources and data transport resources for a wide range of telematics services.

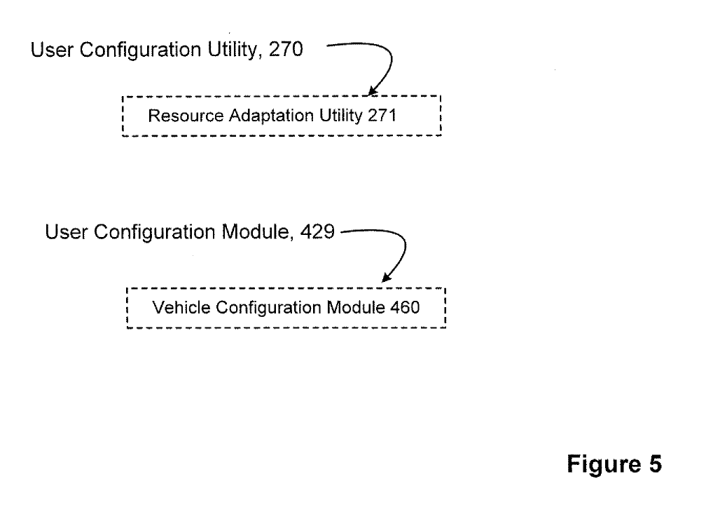

FIG. 5 is a diagram illustrating remote vehicle adaptation in accordance with the example of FIG. 4. In the illustrated embodiment, the user configuration utility 270 comprises a vehicle adaptation utility 271 and the user configuration module 429 comprises a vehicle configuration module 460.

In various embodiments, the vehicle adaptation utility 271 might store vehicle specific electronic networking information for a plurality of vehicle makes and models in a data-base. In some embodiments, it may further provide a web accessible graphical user interface for users to select a particular vehicle and configure the service for this vehicle. When selected, vehicle adaptation utility 271 may send the selected vehicle specific electronic networking information over the air to the VIM.

In the VIM, vehicle configuration utility 460 may receive electronic networking information. Additionally, it may reconfigure the vehicle network drivers 453 based on the information received. In some embodiments, these two components may allow authorized users to remotely configure the telematics service for specific vehicle makes and models after installation of VIM's in vehicles at the time of service activation. Some embodiments might also provide a capability to remotely reconfigure a VIM that has been transferred from a different vehicle.

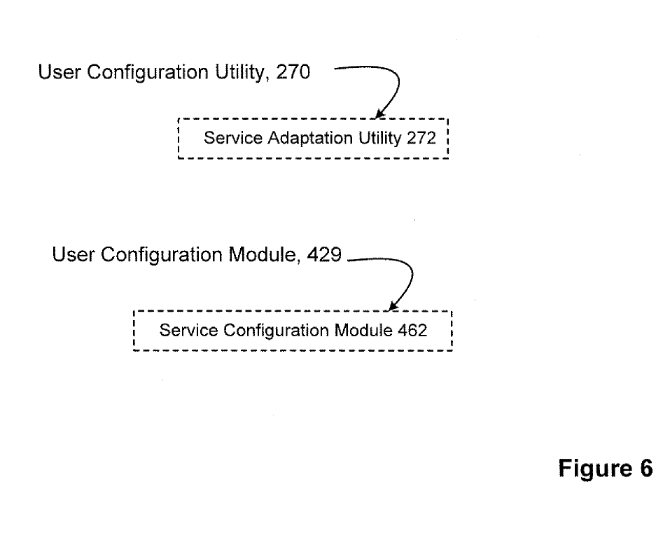

FIG. 6 is a diagram illustrating remote service adaptation in accordance with the example of FIG. 4. In the illustrated embodiment, user configuration utility 270 comprises a service adaptation utility 272 and a user configuration module 429. The user configuration module may comprise a service configuration module 462. In some embodiments, the introduction of these two components may provide authorized users and user groups the capability to remotely select specific telematics services and configure these services with custom parameters. In some embodiments, utility 272 may include a data base of user configurable service parameters. Users may access the utility from a web page and select the desired services from, for example, a list of available services. For each selected service, the utility may offer a list of configurable service parameters for users to select.

In some embodiments, after a user completes a selection, the service adaptation utility 272 may store the selected services along with the defined service parameters for service execution by the user management utility 210. In various embodiments, when users make changes to the selection of service parameters, the user management utility 210 might send the new user selected service parameters over the air to the service configuration module 462.

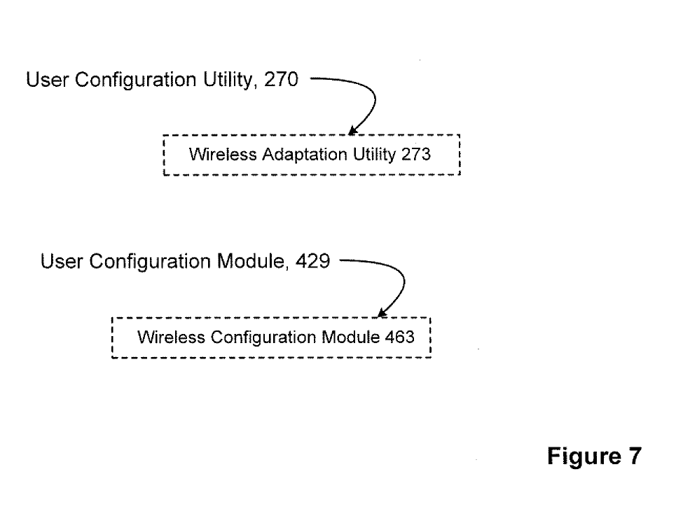

FIG. 7 is a diagram illustrating remote wireless adaptation in accordance with the example of FIG. 4. In some embodiments, as illustrated in FIG. 7, the user configuration utility 270 might comprise a wireless adaptation utility 273 and the user configuration module 429 may comprise a wireless configuration module 463. In some embodiments, the introduction of these two components together with two or more wireless transceivers 456, may allow an authorized user to remotely change and re-prioritize the wireless service connection used to communicate with the wired portion 310 of the global network.

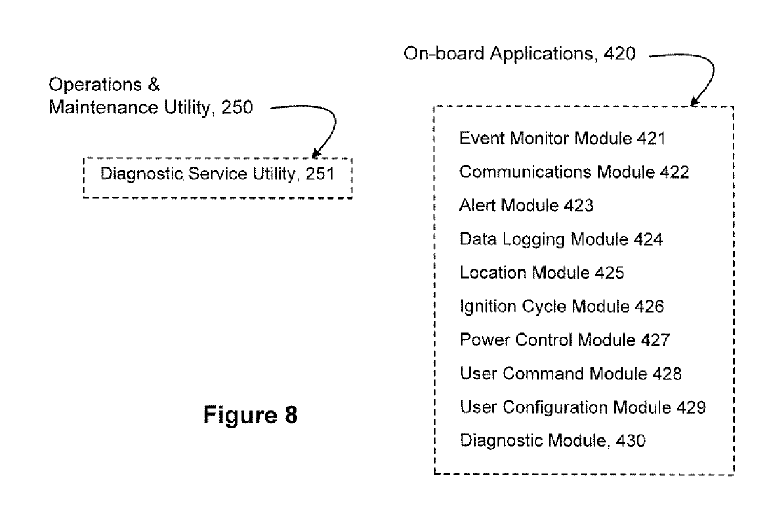

FIG. 8 is a diagram illustrating an example VIM in accordance with the systems and methods described herein. In some embodiments, as illustrated in FIG. 8, VIM diagnostic service utility 251 might be added to the operation and maintenance utility 250 and a diagnostic module 430 may be added to the on-board modules 400. In some embodiments, implementation of these two components in the telematics service architecture may provide authorized users of the telematics service provider the ability to conduct remote diagnostic and perform failure mode analysis on Vim's.

Various embodiments may include functionality to allow for downloadable firmware and software upgrades. For example, a service provider may activate a utility 251 that performs such upgrades. These upgrades might be part of a scheduled diagnostic routine for specific VIM's or in response to an exception mode report from a specific VIM via diagnostic module 430. In some embodiments, the utility might then interact with the diagnostic module 430 to trouble shoot the on-board resources 440. The user might be notified of the results of the trouble shooting. For example, the user might be told that a problem has been found, that no problem has been found, etc. In some embodiments, user notification may allow users to select their notification preferences. For example, in various embodiments, email, phone, SMS, Web based, or other methods of communication might be used to transmit a notification. Additionally, in various embodiments, a user might only be notified when a problem is found. In some embodiments, no VIM interaction is required.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will he apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more,” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

One skilled in the art will appreciate that the present invention can be practiced by other than the various embodiments and preferred embodiments, which are presented in this description for purposes of illustration and not of limitation, and the present invention is limited only by the claims that follow. It is noted that equivalents for the particular embodiments discussed in this description may practice the invention as well. Therefore, the present invention should not be seen as limited to the forms shown, which is to be considered illustrative rather than restrictive.

What is claimed is:

1. A configurable embedded telematics system comprising:
a server suite providing automotive telematics services to a plurality of authorized service users via a global network, the server suite including a user management utility, an application server, a vehicle interface module server, a telematics database, and a user configuration utility; and
a vehicle interface module including an operations controller, an on-board resource and an on-board application comprising an event monitor module, a data logging module, and a user configuration module.

2. The configurable embedded telematics system of claim 1, wherein the vehicle interface module further comprises a communication module configured to control data transport exchange.

3. The configurable embedded telematics system of claim 1, wherein the vehicle interface module further comprises an alert module configured to trigger user alerts.

4. The configurable embedded telematics system of claim 1, wherein the vehicle interface module further comprises a location module configured to process and log location data.

5. The configurable embedded telematics system of claim 1, wherein the vehicle interface module further comprises an ignition cycle module configured to process and log an ignition cycle data set.

6. The configurable embedded telematics system of claim 1, wherein the vehicle interface module further comprises a power control module.

7. The configurable embedded telematics system of claim 1, wherein the vehicle interface module further comprises a user command module.

8. The configurable embedded telematics system of claim 1, wherein the server suite further comprises an operation and maintenance entity configured to provide service infrastructure monitoring and maintenance.

9. The configurable embedded telematics system of claim 8, wherein the operations and maintenance entity further comprises a vehicle interface module diagnostic service utility.

10. The configurable embedded telematics system of claim 1, wherein the user configuration utility comprises a vehicle adaptation utility and the user configuration module comprises a vehicle configuration module.

11. The configurable embedded telematics system of claim 1, wherein the user configuration utility comprises a service adaptation utility and the user configuration module comprises a service configuration module.

12. The configurable embedded telematics system of claim 1, wherein the user configuration utility comprises a wireless adaptation utility and the user configuration module comprises a wireless configuration module.

13. The configurable embedded telematics system of claim 1, wherein the application server is configured to allow a user to set a notification preference.

14. A configurable embedded telematics vehicle interface module comprising:
an operations controller configured to execute a sequence of event driven actions
an on-board application; comprising an event monitor module, a data logging module, and a user configuration module.
a memory configured to store the on-board application, wherein the on-board application comprises a user configuration module.

15. The configurable embedded telematics vehicle interface module of claim 14, wherein the vehicle interface module further comprises a communication module configured to control data transport exchange.

16. The configurable embedded telematics vehicle interface module of claim 14, wherein the vehicle interface module further comprises an alert module configured to trigger user alerts.

17. The configurable embedded telematics vehicle interface module of claim 14, wherein the vehicle interface module further comprises a location module configured to process and log location data.

18. The configurable embedded telematics vehicle interface module of claim 14, wherein the vehicle interface module further comprises an ignition cycle module configured to process and log an ignition cycle data set.

19. The configurable embedded telematics vehicle interface module of claim 14, wherein the vehicle interface module further comprises a power control module.

20. The configurable embedded telematics vehicle interface module of claim 14, wherein the vehicle interface module further comprises a user command module.

21. The configurable embedded telematics vehicle interface module of claim 14, wherein the user configuration module comprises a vehicle configuration module.

22. The configurable embedded telematics vehicle interface module of claim 14, wherein user configuration module comprises a service configuration module.

23. The configurable embedded telematics vehicle interface module of claim 14, wherein the user configuration module comprises a wireless configuration module.
